(19) United States
(12) Patent Application Publication
(10) Pub. No.: US 2020/0115591 A1
(43) Pub. Date: Apr. 16, 2020

(54) BONDING AGENT COMPOSITION

(71) Applicants: THYSSENKRUPP STEEL EUROPE AG, DUISBURG (DE); THYSSENKRUPP AG, ESSEN (DE)

(72) Inventors: THOMAS LOSTAK, NEUKIRCHEN-VLUYN (DE); STELLA JANSSEN, DÜSSELDORF (DE); FLORIAN ROLLBUSCH, WITTEN (DE); KLAUS-PETER KOCH, SCHWELM (DE)

(21) Appl. No.: 16/484,197

(22) PCT Filed: Feb. 1, 2018
(86) PCT No.: PCT/EP2018/052470

§ 371 Date: Aug. 7, 2019

(30) Foreign Application Priority Data
Feb. 7, 2017 (DE) 102017201868.2

(51) Int. Cl. C09J 5/02; C09J 7/10; C09J 133/02; C09J 7/35; C09J 7/38; B32B 15/088; B32B 15/18; C08G 69/44

(52) U.S. Cl. CPC C09J 5/02; B32B 2605/08; C09J 133/02; C09J 7/35; C09J 7/381; B32B 15/088; B32B 15/18; C08G 69/44; C09J 2400/163; C09J 2477/006; B32B 2250/03; B32B 2250/40; B32B 2255/06; B32B 2311/20; B32B 2311/30; B32B 2377/00; C09J 7/10

(57) ABSTRACT

An adhesion promoter composition foregoes the use of toxic heavy metals and also features a relatively large add-on window for an adhesion functioning in the assembly. The adhesion promoter composition is an aqueous solution comprising (a) ¼-3 parts by weight of a polymer selected from the maleic acid/polyacrylic acid copolymer, modified polyacrylic acid, or polyacrylic acid groups; (b) 1 part by weight of a phosphate component; and optionally (c) 1/10 to 5/10 parts by weight of a metal-containing component selected from the Zn, Ca, Mg and/or Al group.

### CROSS-REFERENCE TO RELATED APPLICATIONS

This application is the U.S. national phase of, and claims priority to, International Application No. PCT/EP2018/052470, filed Feb. 1, 2018, which designated the U.S. and which claims priority to DE Patent No. 10 2017 201 868.2, field Feb. 7, 2017. These applications are each incorporated by reference herein in their entireties.

### TECHNICAL FIELD

The invention relates to an adhesion promoter composition which forgoes the use of toxic heavy metals and also features a relatively large add-on window for an adhesion functioning in the assembly. The invention further relates to a composite material comprising an adhesion promoter layer based on the adhesion promoter composition of the invention. A further aspect of the present invention relates to a method for producing the composite material, and also to the use of the composite material.

### TECHNICAL BACKGROUND

Vehicle construction is increasingly using composite materials in order to reduce the unladen weight of the bodies. Such composite materials are sandwiched constructions which in addition to metallic components such as thin galvanized sheets, for example, also comprise organic materials, such as organic polymers, for example. These materials combine the high strength of the steel with the low weight of the plastic used.

The lifetime of the assembly in these sandwiched constructions is determined by the boundary layer between the metal oxide and the polymer used. Industrial deployment of these materials necessitates the development of a stable and permanent adhesion between the various materials. In order to ensure this, agents known as adhesion promoters or primers are employed.

These adhesion promoters, typically, are aqueous conversion solutions which can be applied by various methods to metallic substrates. A particular feature of these systems is that they are usually acidic aqueous solutions which dissolve the metallic base substrate. This dissolution of metal leads to an increase in the pH close to the interface, and to subsequent precipitation of inorganic reaction products, which are responsible for the advantageous properties of these coatings.

From the laid-open specification DE 10 2014 007 715 A1 it is known that phosphating processes based on acidic metal phosphates in the presence of polyacrylic acid produce an adhesion-promoting layer. This coating generates sufficiently high adhesion in a sandwiched assembly consisting of a thin galvanized sheet and an organic polymer. Besides these constituents, this product formulation comprises a range of toxic heavy metals such as manganese compounds, chromium(III) compounds and iron(II)/(III) compounds.

### SUMMARY OF THE INVENTION

One object of the invention is to provide an improved adhesion promoter composition. In some embodiments, an adhesion promoter composition, without using toxic heavy metals, offers a large add-on window for an adhesion functioning in the assembly.

### DETAILED DESCRIPTION OF THE INVENTION

Advantageous embodiments and variants of the invention are apparent from the description provided herein. In embodiments, the adhesion promoter composition of the invention is an aqueous solution comprising: (a) ¼-3 parts by weight of a polymer selected from the maleic acid/polyacrylic acid copolymer, modified polyacrylic acid, or polyacrylic acid group, (b) 1 part by weight of a phosphate component, and optionally (c) 1/10 to 5/10 parts by weight of a metal-containing component selected from the Zn, Ca, Mg and/or Al group.

Surprisingly it has emerged that through the use of the adhesion promoter composition of the invention in the production of composite materials it is possible to achieve very high levels of adhesion.

As described herein, the aqueous solution of the adhesion promoter composition of the invention comprises ¼ to 3 parts by weight of a polymer. The polymer in this case is selected from the maleic acid/polyacrylic acid copolymer, modified polyacrylic acid, or polyacrylic acid group. In one preferred embodiment, mixtures thereof are also used as polymer. In some embodiments, the polymer is a mixture of (a) maleic acid/polyacrylic acid copolymer and modified polyacrylic acid, (b) maleic acid/polyacrylic acid copolymer and polyacrylic acid, or (c) polyacrylic acid and modified polyacrylic acid.

In embodiments, the aqueous solution contains the following ratios of polymer to the phosphate component: ¼:1; ⅓:1; 1:1; 2:1 or 3:1, the polymer being selected from the maleic acid/polyacrylic acid copolymer, modified polyacrylic acid, or polyacrylic acid group.

According to some embodiments, the aqueous solution comprises a pH in the range from 2 to 3, 2.2 to 2.8, or 2.4 to 2.6.

The aqueous solution may further include a wetting agent selected from the group of the alcohols. The wetting agent may be, for example, ethanol or ethylene glycol. The amount of the wetting agent in the aqueous solution may be about 0.5 to 1 part by weight

According to some embodiments, the copolymer comprises a molar mass in the range from about 50,000 to 100,000 g/mol and the polyacrylic acid comprises a molar mass in the range from about 1000 to 300,000 g/mol. The stated molar masses are average molar masses determined by gel permeation chromatography. The calibrating agent used was polystyrenesulfonate. The polymer may be a maleic acid/polyacrylic acid copolymer having an average molar mass in the range of about 50,000-100,000 g/mol, or about 60,000-80,000 g/mol. In certain embodiments, the copolymer is a maleic acid/polyacrylic acid copolymer having an average molar mass of about 70,000 g/mol.

The polymer may be a modified polyacrylic acid having an average molar mass in the range of about 1000-5000 g/mol. In some embodiments, the polymer has an average molar mass of about 3000 g/mol.

In some embodiments, the polymer is a polyacrylic acid having an average molar mass in the range of 50,000-300,000 g/mol. The polyacrylic acid may have an average molar mass in the range of about 80,000-120,000 g/mol, or about 100,000 g/mol. In still other embodiments the polyacrylic acid has an average molar mass in the range of about 200,000-300,000 g/mol, or about 250,000 g/mol.

According to embodiments of the invention, the aqueous solution contains no toxic heavy metals. Toxic heavy metals in the sense of the present invention are essentially metals which in elemental form comprise a density of greater than 5.0 g/cm³. Excepted from this in the sense of the present invention are the essential heavy metals including iron, manganese, molybdenum, copper, and zinc, which form the essential dietary constituents.

The adhesion promotor may be utilized in the production of a composite material. A composite material may include two metal sheets, connected by means of a thermoplastic polymeric film, and an adhesion promoter layer which is disposed between sheet and film in each case and comprises the adhesion promoter composition of the invention, more particularly the dried adhesion promoter composition of the invention. The adhesion promoter layer may have a dry layer weight of about 10 to 60 mg/m² based on the phosphate content. In some embodiments, the adhesion promoter layer comprises a dry layer weight of about 20 to 50 mg/m² based on the phosphate content.

The thickness of the sheets is preferably about 0.15 to 3 mm, although the thickness of the sheets is not limited to such thicknesses. The metal sheet is preferably an electrolytic or hot dip galvanized steel sheet, although other metal sheets may alternately be appropriate. In some embodiments the metal sheet is a hot dip galvanized zinc-magnesium steel sheet. In other embodiments the metal sheet is formed of a CRS steel (cold-rolled steel). In still other embodiments the metal sheet is formed of stainless steel or aluminum.

The thickness of the film may be about 50 to 5000 μm, and preferably but not necessarily about 200 to 1000 μm. The film may be, for example, a grafted polyethylene-polyamide 6 mixture.

The invention further relates to a method for producing a composite material. The method may include the following steps: (a) providing two metal sheets, (b) coating the sheets with an adhesion promoter composition of the invention, (c) uniting the coated steel sheets with disposition of a thermoplastic polymeric film so as to produce an assembly, and (d) connecting the assembly to give the composite material. According to some embodiments, the coated metal sheets are subjected to a drying step before being united.

The thickness of the sheets may be about 0.15 to 3 mm. The metal sheet may be an electrolytic or hot dip galvanized steel sheet, for example, a hot dip galvanized zinc-magnesium steel sheet, a CRS steel, a stainless steel, or aluminum. In embodiments, the thickness of the film is about 50 to 5000 μm, or about 200 to 1000 μm. The film may be a grafted polyethylene-polyamide 6 mixture.

The adhesion promoter composition may be applied in an amount such as to leave a dry layer weight of 10 to 60 mg/m² based on the phosphate content.

The composite material of the invention, which may be produced as described herein, may be used in the construction of many different structures, including but not limited to motor vehicle construction, aircraft construction, rail vehicle construction, or the construction of buildings.

### EXAMPLES

In the text below, the invention is elucidated in more detail, using examples.

Preparation of the Adhesion Promoter Composition of the Invention

The compositions shown in table 1 below were prepared using the following substances.
Solvent: fully demineralized water (FD water)
Polymer A: maleic acid/acrylic acid copolymer from the Sokalan CP series
Polymer B: modified polyacrylic acid from the Sokalan CP series
Polymer C: polyacrylic acid from the Sokalan PA series
Phosphate component: phosphoric acid
Metal-containing component: ZnO, CaCO₃, MgHPO₄, Al(NO₃)₃
Wetting agents: ethanol, ethylene glycol
   Nitric acid was used to adjust the pH. The aqueous solutions were adjusted to a pH in the range of 2.3-2.6. All data is quoted in g/L, the ratios being based consistently on 1 part by weight of PO₄³⁻.

TABLE 1

| | ADP1 | ADP2 | ADP3 | ADP4 | ADP5 | ADP6 | ADP7 | ADP8 | ADP9 | ADP10 | ADP11 | ADP12 |
|---|---|---|---|---|---|---|---|---|---|---|---|---|
| PO₄³⁻ | 30 | 50 | 50 | 50 | 50 | 50 | 50 | 50 | 50 | 50 | 50 | 50 |
| A | 8.5 | 50 | 150 | 100 | 50 | 50 | 50 | 50 | 50 | 50 | | |
| B | | | | | | | | | | | 50 | |
| C | | | | | | | | | | | | 50 |
| Al | | | | | | | | | 25 | | | |
| Ca | | | | | 5 | | | | | | | |
| Mg | | | | | | 5 | | | | 5 | 5 | 5 |
| Zn | | | | | | | 5 | | | | | |
| Ethanol | | | | | | | | 25 | 25 | 25 | | |
| Ethylene | | | | | | | | | | | 25 | 25 |
| glycol | | | | | | | | | | | | |

Production of the Composite Materials of the Invention

Composite materials of the invention were produced by coating galvanized steel sheets (20×20 cm) with the respective compositions by means of a Chem-Coater coating unit. The add-on was determined using an RFA hand spectrometer (tracer element phosphorus). The coated steel sheets were then dried in a continuous oven at a temperature in the range from 80 to 120° C. The residence time was 20 to 40 seconds. A metal-polymer-metal assembly was subsequently produced by means of a platen press. For this purpose, the assembly was pressed for 30-150 s at a temperature of 200-250° C. and a pressure of 15-25 bar. The polymer used was a thermoplastic polymer film 0.4 mm thick and consisting of a grafted polyethylene-polyamide 6 mixture. From the composite material then obtained, test specimens were produced, and were measured in a T-peel tensile test at a testing speed of 100 mm/min. This test took place on the basis of DIN EN ISO 11339. The results are set out in table 2 below.

TABLE 2

| | ADP1 | ADP2 | ADP3 | ADP4 | ADP5 | ADP6 | ADP7 | ADP8 | ADP9 | ADP10 | ADP11 | ADP12 |
|---|---|---|---|---|---|---|---|---|---|---|---|---|
| Layer weight | 10-20 | 15-30 | 10-30 | 20-50 | 10-30 | 10-60 | 15 | 60 | 20-60 | 20-50 | 20-50 | 20 |
| [mg PO₄³⁻/m²] | | | | | | | | | | | | |
| Peel value | 730-765 | 685-750 | 765-820 | 510-710 | 600-805 | 630-750 | 750 | 750 | 540-730 | 670-730 | 500-660 | 560 |
| [N/4 cm] | | | | | | | | | | | | |

1. An adhesion promoter composition consisting of an aqueous solution comprising:
¼-3 parts by weight of a polymer selected from the list consisting of: a maleic acid/polyacrylic acid copolymer, a modified polyacrylic acid, and a polyacrylic acid group; and
1 part by weight of a phosphate component.

2. The adhesion promoter composition as claimed in claim 1, wherein the aqueous solution comprises a pH in the range from 2 to 3.

3. The adhesion promoter composition as claimed in claim 1, wherein the aqueous solution further comprises a wetting agent selected from the group of the alcohols.

4. The adhesion promoter composition as claimed in claim 3, wherein the amount of the wetting agent in the aqueous solution is 0.5 to 1 part by weight.

5. The adhesion promoter composition as claimed in claim 1, wherein the copolymer comprises a molar mass in the range from 50,000 to 100,000 g/mol and the polyacrylic acid comprises a molar mass in the range from 1000 to 300,000 g/mol.

6. The adhesion promoter composition as claimed in claim 1, wherein the aqueous solution contains no toxic heavy metals.

7. A composite material, comprising:
two metal sheets connected by means of a thermoplastic polymeric film; and
an adhesion promoter layer disposed between the respective sheets and the film
wherein the adhesion promoter comprises an adhesion promoter composition as claimed in claim 1.

8. The composite material as claimed in claim 7, wherein the adhesion promoter layer comprises a dry layer weight of 10 to 60 mg/m² based on the phosphate content.

9. The composite material as claimed in claim 7, wherein the thickness of the sheets is between 0.15 and 3 mm.

10. The composite material as claimed in claim 9, wherein the thickness of the film is between 50 and 5000 μm.

11. A method for producing a composite material, comprising the steps of:
(a) providing two metal sheets;
(b) coating the sheets with an adhesion promoter composition as claimed in claim 1;
(c) uniting the coated steel sheets with disposition of a thermoplastic polymeric film so as to produce an assembly; and
(d) connecting the assembly to give the composite material.

12. The method as claimed in claim 11, wherein the coated metal sheets are subjected to a drying step before uniting with the thermoplastic polymeric film.

13. The method as claimed in claim 12, wherein the adhesion promoter composition is applied in an amount such as to leave a dry layer weight of 10 to 60 mg/m² based on the phosphate content.

14. The method as claimed in claim 13, wherein the assembly is pressed at a temperature of 200-250° C. and a pressure of 15-25 bar.

15. (canceled)

16. The adhesion promoter composition as claimed in claim 1, further comprising 1/10 to 5/10 parts by weight of a metal containing component selected from the list consisting of: the Zn group, the Ca group, the Mg group, and the Al group.

17. The adhesion promoter composition as claimed in claim 16, wherein the aqueous solution further comprises a wetting agent selected from the group of the alcohols.

18. The adhesion promoter composition as claimed in claim 17, wherein the amount of the wetting agent in the aqueous solution is 0.5 to 1 part by weight.

19. The adhesion promoter composition as claimed in claim 18, wherein the copolymer comprises a molar mass in the range from about 50,000 to 100,000 g/mol and the polyacrylic acid comprises a molar mass in the range from about 1000 to 300,000 g/mol.

20. The adhesion promoter composition as claimed in claim 19, wherein the aqueous solution contains no toxic heavy metals.

21. The method as claimed in claim 14, wherein the thermoplastic polymeric film is a grafted polyethylene polyamide 6 mixture.
